(19) United States
(12) Patent Application Publication
(10) Pub. No.: US 2024/0143884 A1
(43) Pub. Date: May 2, 2024

(54) ELECTROMAGNETIC TRANSIENT SIMULATION METHOD AND APPARATUS FOR VOLTAGE SOURCE CONVERTER, DEVICE, AND MEDIUM

(71) Applicant: North China Electric Power University, Beijing (CN)

(72) Inventors: Shujun YAO, Beijing (CN); Yan WANG, Beijing (CN); Jin LIU, Beijing (CN)

(21) Appl. No.: 18/171,230

(22) Filed: Feb. 17, 2023

(30) Foreign Application Priority Data
Sep. 22, 2022 (CN) 202211159668.1

(51) Int. Cl. G06F 30/367; G06F 17/16

(52) U.S. Cl. CPC G06F 30/367; G06F 17/16; G06F 2113/04

(57) ABSTRACT

An electromagnetic transient simulation method and apparatus for a voltage source converter (VSC), an electronic device, and a storage medium are provided. The method mainly includes: performing circuit equivalence processing on a voltage source converter with any quantity of ports based on a work mechanism of the voltage source converter; performing discretization processing on the equivalent circuit, to obtain an equivalent target circuit, and determining a node admittance matrix expression and a historical current source expression according to the equivalent target circuit; and constructing a multi-port Norton equivalent model corresponding to the voltage source converter according to the node admittance matrix expression and the historical current source expression, and performing electromagnetic transient simulation on the voltage source converter by using the multi-port Norton equivalent model, to obtain a simulation result.

### CROSS-REFERENCE TO RELATED APPLICATION

This patent application claims the benefit and priority of Chinese Patent Application No. 202211159668.1 filed with the China National Intellectual Property Administration on Sep. 22, 2022, the disclosure of which is incorporated by reference herein in its entirety as part of the present application.

### TECHNICAL FIELD

The present disclosure relates to the technical field of electromagnetic transient simulation, and in particular, to an electromagnetic transient simulation method and apparatus for a voltage source converter (VSC), an electronic device, and a storage medium.

### BACKGROUND

The power system field is changing greatly, and the electromagnetic transient characteristics of the power system become increasingly complex. Through accurate modeling and detailed and rapid electromagnetic transient simulation analysis of related components of the power system, the dynamic characteristics of the power system can be accurately grasped, which provides important help for the planning, design, construction, development, and operation practice of the power system.

With the continuous expansion of the scale of alternating current (AC) and direct current (DC) power grids, requirements for rapidity and accuracy of electromagnetic transient simulation are increased, and the electromagnetic transient simulation of new power system faces the following problems:
(1) The power grid is expanded. In an existing electromagnetic transient simulation numerical algorithm, whether a state space method or a node voltage method needs to finally solve linear algebraic equations simultaneously, and an amount of calculation and an order of the equations are in a cubic relationship. Consequently, a simulation speed will decline sharply with the increase of the system scale and become unacceptable. The current AC/DC hybrid power grid has a large scale, a large amount of devices, and a total scale of nearly 30,000 simulation nodes. Such a large-scale system faces a problem of solving an ultra-high-order linear algebraic equations if an existing numerical algorithm is directly used. Therefore, it is necessary to research an efficient calculation method to implement that a relationship between the amount of calculation and the system scale is less than or approximate to a linear relationship.
(2) The device characteristics are complex. With the research and deep analysis of various linear and nonlinear models such as a converter, a new energy station, a complex control system, and an information physical system, when researchers use electromagnetic transient simulation as a tool for research, the research objects and purposes are also complex and diverse, and power electronic devices with more complex characteristics have emerged. The power electronic devices have different performance, frequent switching actions, and time-varying and nonlinear characteristics, and the calculation efficiency of models thereof directly affects the electromagnetic transient simulation speed of the whole network. Therefore, it is necessary to research a modeling theory or method for the power electronic devices with high calculation efficiency.
(3) The topology is more diverse. With the deep study of energy transmission, in order to meet multi-directional flow, the power electronic device often needs to adopt multi-stage and/or multi-port structures and often connect ports and converter stages in series or in parallel, and the ports and the converter stages are electrically and electromagnetically coupled closely. The device topology is more complex and diverse. Therefore, a general modeling method that can unify different topological structures is required.

Electromagnetic transient simulation needs to be accurate and fast. However, the changes in the above three aspects have made the contradiction between the accuracy and the speed of simulation of the VSC more prominent. The existing methods are difficult to apply, and urgently need to be improved, or a new method needs to be proposed.

### SUMMARY

An objective of embodiments of the present disclosure is to provide an electromagnetic transient simulation method and apparatus for a VSC, a device, and a medium, so that electromagnetic transient simulation on a VSC can be accurate and fast.

To achieve the above objective, the present disclosure provides the following technical solutions.

According to a first aspect, the present disclosure provides an electromagnetic transient simulation method for a VSC, including:
performing circuit equivalence processing on a VSC with any number of ports based on a work mechanism of the VSC, to obtain an equivalent circuit corresponding to the VSC, where the work mechanism is a mechanism in which an inductor open circuit and a capacitor short circuit are not allowed inside the VSC during normal operation; the equivalent circuit includes a DC side and an AC side; the DC side includes three DC side port nodes, two port capacitors, and two controlled current sources, where a first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the controlled current sources are current injected into the DC side port nodes from all port branches of the AC side; and the AC side includes one or more equivalent sub-circuits separately represented by the DC sides and the AC side, and the equivalent sub-circuit includes one AC side port node, one port inductor, one total resistor, and one switch, where the AC side port node is connected to one end of the switch sequentially by the port inductor and the total resistor, and the other end of the switch is configured to connect any one of the DC side port nodes, and the total resistor represents a total resistor when the equivalent sub-circuit is turned on;
performing discretization processing on the equivalent circuit, to obtain an equivalent target circuit, where the equivalent target circuit is a discretized equivalent circuit;
determining a node admittance matrix expression and a historical current source expression according to the equivalent target circuit;
constructing a multi-port Norton equivalent model corresponding to the VSC according to the node admittance matrix expression and the historical current source expression; and
performing electromagnetic transient simulation on the VSC by using the multi-port Norton equivalent model, to obtain a simulation result.

According to a second aspect, the present disclosure provides an electromagnetic transient simulation apparatus for a VSC, including:
an equivalent circuit determining module, configured to perform circuit equivalence processing on a VSC with any number of ports based on a work mechanism of the VSC, to obtain an equivalent circuit corresponding to the VSC, where the work mechanism is a mechanism in which an inductor open circuit and a capacitor short circuit are not allowed inside the VSC during normal operation; the equivalent circuit includes a DC side and an AC side; the DC side includes three DC side port nodes, two port capacitors, and two controlled current sources, where a first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the controlled current sources are current injected into the DC side port nodes from all port branches of the AC side; and the AC side includes one or more equivalent sub-circuits separately represented by the DC side and the AC side, and the equivalent sub-circuit includes one AC side port node, one port inductor, one total resistor, and one switch, where the AC side port node is connected to one end of the switch sequentially by the port inductor and the total resistor, and the other end of the switch is configured to connect any one of the DC side port nodes, and the total resistor represents a total resistor when the equivalent sub-circuit is turned on;
an equivalent target circuit determining module, configured to perform discretization processing on the equivalent circuit, to obtain an equivalent target circuit, where the equivalent target circuit is a discretized equivalent circuit;
a node admittance matrix expression and historical current source expression determining module, configured to determine a node admittance matrix expression and a historical current source expression according to the equivalent target circuit;
a multi-port Norton equivalent model determining module, configured to construct a multi-port Norton equivalent model corresponding to the VSC according to the node admittance matrix expression and the historical current source expression; and
a simulation module, configured to perform electromagnetic transient simulation on the VSC by using the multi-port Norton equivalent model, to obtain a simulation result.

According to a third aspect, the present disclosure provides an electronic device, including a memory and a processor, the memory is configured to store a computer program, and the processor runs the computer program, to cause the electronic device to perform the electromagnetic transient simulation method for a VSC according to the first aspect.

According to a fourth aspect, the present disclosure provides a computer-readable storage medium, storing a computer program, the computer program is executed by a processor to implement the electromagnetic transient simulation method for a VSC according to the first aspect.

According to the specific embodiments according to the present disclosure, the present disclosure discloses the following technical effects.
1. The equivalent circuit is simple, and the model has good universality and scalability.

In the present disclosure, according to a fact that an inductor branch cannot be short circuited and a capacitor branch cannot be open circuited in the VSC, an equivalent circuit corresponding to the VSC is obtained, which is not only suitable to a half bridge, an H-bridge, and a VSC, but also suitable to a VSC with any multi-port. Based on a working principle of the VSC, the equivalent circuit obtained is simple in form and universal. When a number of external ports in the VSC changes, only corresponding equivalent sub-circuits need to be added or deleted in the equivalent circuit, and only a dimension needs to be changed in a node admittance matrix expression and a historical current source expression, and corresponding variables can be accumulated at corresponding positions, which has good scalability.
2. The node admittance matrix expression and the historical current source expression have clear physical meaning and are concise and efficient.

According to the technical solution of the present disclosure, corresponding element values in the node admittance matrix expression and the historical current source expression can be directly obtained from the physical meaning of an equivalent circuit diagram, and then simplified by using a switch combination and a corresponding discretization method, so that a solution process of the node admittance matrix and the historical current source is simple and efficient, and the physical meaning is clear.
3. Calculation speed is fast.

In the present disclosure, by simplifying the modeling method, values of the node admittance matrix and the historical current source can be quickly obtained through general formulas without matrix operations. In each step of simulation calculation, when a switch action causes the node admittance matrix to change, it is only necessary to modify values of elements at corresponding positions in the node admittance matrix and the historical current source. Because a same node is only directly connected to only a few nodes, only a few elements need to be modified each time the switch action is performed. In addition, a number corresponding to the external port is directly solved in the calculation process, which reduces the number of calculation nodes, improves the efficiency of inverse solution, and speed up the simulation speed.

### BRIEF DESCRIPTION OF THE DRAWINGS

To describe the embodiments of the present disclosure or the technical solutions in the related art more clearly, the accompanying drawings required in the embodiments are briefly introduced below. Apparently, the accompanying drawings described below are only some embodiments of the present disclosure. Those of ordinary skill in the art may further obtain other accompanying drawings based on these accompanying drawings without creative labor.

FIG. 1 is a schematic flowchart of an electromagnetic transient simulation method for a VSC according to the present disclosure.

FIG. 2 is a topology diagram of any multi-port VSC according to the present disclosure.

FIG. 3 is a diagram of an equivalent circuit corresponding to any multi-port VSC according to the present disclosure.

FIG. 4 is a diagram of an equivalent target circuit corresponding to any multi-port VSC according to the present disclosure.

FIG. 5 is a schematic diagram of an electromagnetic transient simulation process for a VSC according to the present disclosure.

FIG. 6 is a topology diagram of a half-bridge circuit according to the present disclosure.

FIG. 7 is a diagram of an equivalent circuit corresponding to a half-bridge circuit according to the present disclosure.

FIG. 8 is a topology diagram of an H-bridge circuit according to the present disclosure.

FIG. 9 is a diagram of an equivalent circuit corresponding to an H-bridge circuit according to the present disclosure.

FIG. 10 is a topology diagram of a VSC three-phase circuit according to the present disclosure.

FIG. 11 is a diagram of an equivalent circuit corresponding to a VSC three-phase circuit according to the present disclosure.

FIG. 12 is a topology diagram of an NPC three-level VSC model circuit according to the present disclosure.

FIG. 13 is a diagram of an equivalent circuit corresponding to an NPC three-level VSC model circuit according to the present disclosure.

FIG. 14 is a topology diagram of a T-type three-level VSC model circuit according to the present disclosure.

FIG. 15 is a diagram of an equivalent circuit corresponding to a T-type three-level VSC model circuit according to the present disclosure.

FIG. 16 is a schematic structural diagram of an electromagnetic transient simulation apparatus for a VSC according to the present disclosure.

### DETAILED DESCRIPTION OF THE EMBODIMENTS

Clear and complete description will be made on technical solution in the embodiment of the present disclosure below in combination with drawings in the embodiment of the present disclosure. Apparently, the described embodiments are merely a part of embodiments of the present disclosure and are not all the embodiments. All other embodiments obtained by those of ordinary skill in the art based on the embodiments of the present disclosure without creative efforts shall fall within protection scope of the present disclosure.

To make the above-mentioned objective, features, and advantages of the present disclosure clearer and more comprehensible, the present disclosure will be further described in detail below in conjunction with the accompanying drawings and specific implementations.

Existing electromagnetic transient simulation models of VSCs strive to achieve a compromise between accuracy of the simulation model and simulation efficiency. The existing electromagnetic transient simulation models of the VSCs may be roughly divided into three categories, namely detailed model, dynamic phasor model and multi-port equivalent model.

In detailed model, all control systems and capacitor voltage calculation records of the converter are retained, which can be used to analyze abnormal problems inside the converter, for example, harmonic analysis. However, in condition of the transient behavior of semiconductor switch, the detailed model retains a complete topology of the converter, and thus a large number of electrical nodes need to be solved, and a fast algorithm for solving nonlinear switch events is also required, and the calculation method have a capability of solving the “stiff” differential equation. Therefore, the overall calculation time is very long, which is mainly used to verify other simplified equivalent models, and is not suitable for simulation modeling of a large-scale power system.

In dynamic phasor model, phasor description is used and an essence thereof is to construct a dynamic phasor model described by slowly varying analytic signals from a high-frequency changing instantaneous value model represented by a switching function in electromagnetic transient simulation through a transformation method. The dynamic phasor model can be solved by using either a state space method or a node analysis method. In theory, the dynamic phasor model can approach the precision of the detailed model when sufficient orders are taken into account. However, during actual application, with the increase of a system scale and the limitation of a hardware capability of a computing platform, orders of equations increase and the computing speed decreases.

In multi-port equivalent model, a dual-layer simulation policy of a system and a device is implemented by using a nesting idea. At a system level, multi-port equivalence is performed on a converter and the converter participates in simulation of the entire system as a whole. After the system level simulation is completed and port characteristics are obtained, device level simulation is performed to calculate internal characteristics of the converter and update a historical current source and a port admittance matrix at a next moment. However, the processes of external port equivalence of the converter at the system level and the solution of the entire system to obtain the port characteristics, and the process of inverse solution of the internal characteristics at the device level all involve matrix operations. A large amount of matrix operations will lower the solution efficiency, especially when the system is complex. In addition, this method also forms a node admittance matrix through the matrix operation, which cannot make use of a physical nature of the circuit to simplify and speed up the process.

Under the background of large-scale power grid, the existing electromagnetic transient simulation model of the VSC has a contradiction between accuracy and calculation efficiency. Therefore, the present disclosure provides an electromagnetic transient simulation method and apparatus for a VSC, a device, and a medium, which resolve the technical problem that the multi-port equivalent model cannot be quickly modeled and efficiently solved.

### Embodiment 1

With the development of new power system construction, a quantity of new energy stations is increasing, and a large amount of VSCs will appear, which brings new challenges to electromagnetic transient simulation of the a new power system. Although some of the existing VSC models such as the detailed model have high accuracy, the amount of calculation is large, the simulation speed is very slow, and the efficiency is low, which is apparently not suitable for analysis of a large system. In view of this, an embodiment of the present disclosure provides an electromagnetic transient simulation method for a VSC.

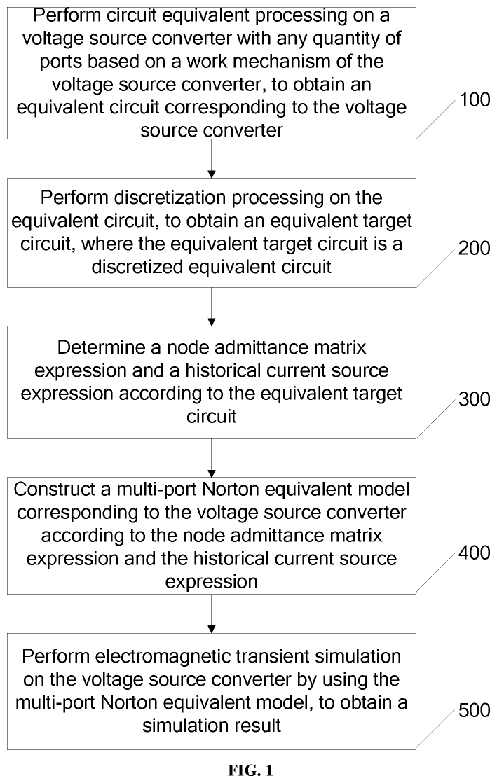

As shown in FIG. 1, this embodiment provides an electromagnetic transient simulation method for a VSC, including the following step 100-step 500.

In step 100, circuit equivalence processing is performed on a VSC with any quantity of ports based on a work mechanism of the VSC, to obtain an equivalent circuit corresponding to the VSC. The work mechanism is a mechanism in which an inductor open circuit and a capacitor short circuit are not allowed inside the VSC during normal operation. The equivalent circuit includes a DC side and an AC side; the DC side includes three DC side port nodes, two port capacitors, and two controlled current sources. A first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the controlled current sources are current injected to the DC side port nodes from all port branches of the AC side. The AC side includes one or more equivalent sub-circuits separately represented by the DC side and the AC side, and the equivalent sub-circuit includes one AC side port node, one port inductor, one total resistor, and one switch. The AC side port node is connected to one end of the switch sequentially by the port inductor and the total resistor, and the other end of the switch is configured to connect any one of the DC side port nodes, and the total resistor represents a total resistor when the equivalent sub-circuit is turned on.

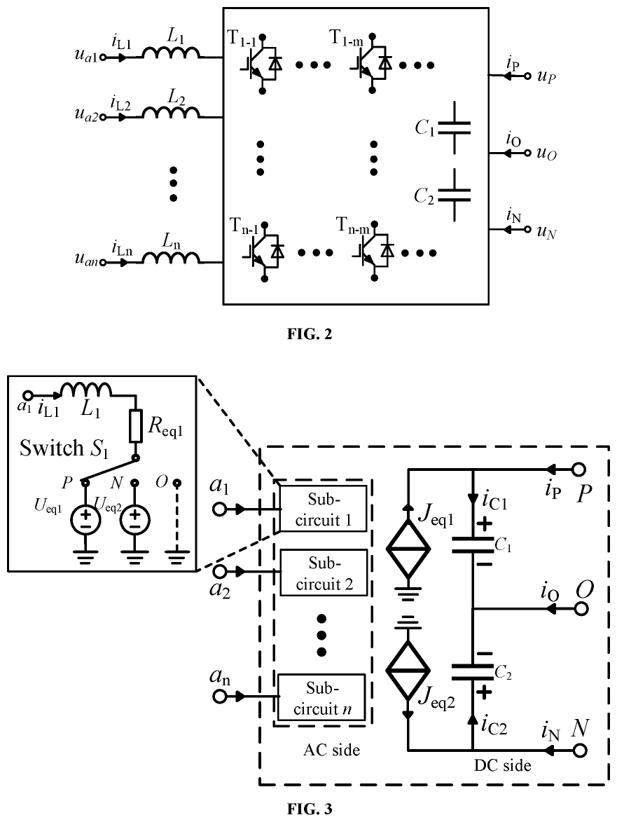

FIG. 2 is a topology diagram of any multi-port VSC according to the present disclosure. L₁ to Lₙ are port inductors when an AC side of a VSC is connected to an external system, T₁₋₁ to T₁₋ₘ represent m switches in a first branch, Tₙ₋₁ to Tₙ₋ₘ represent m switches in an n^{th} branch, and C₁ and C₂ are port capacitors on a DC side of the VSC. uₐ₁ to uₐₙ are port voltages on the AC side of the VSC, iₐ₁ to iₐₙ are port current on the AC side of the VSC, u_{P}, u_{O}, and u_{N} are port voltage on the DC side of the VSC, and i_{P}, i_{O}, and i_{N} are port current on the DC side of the VSC. Different values of n may represent VSCs with different number of ports on the AC side.

It is known that an inductor open circuit and a capacitor short circuit are not allowed inside the VSC during normal operation. Any multi-port VSC shown in FIG. 2 may be equivalent, to obtain an equivalent circuit shown in FIG. 3.

An equivalent sub-circuit 1 is used as an example, and it is assumed that a set of all associated switches when an AC side port node (a₁) is connected to DC side port nodes (P, N, and O) in an original circuit (that is, any multi-port VSC shown in FIG. 2) is T₁ (which is represented by S₁ in the equivalent sub-circuit 1). As required by an output voltage of the AC side port node (a₁), T₁ may be connected to the DC side port nodes (P, N, and O) according to different switch combinations. For example, when the output voltage is u_{P}, the switch S₁ is connected to the DC side port node P, when the output voltage is u_{N}, the switch S₁ is connected to the DC side port node N, and when the output voltage is 0, the switch S₁ is connected to the DC side port node O. R_{eq1} represents a total resistance of a conduction path formed when the AC side port node a₁ is connected to different DC side port nodes (P, N, and O). J_{eq1} and J_{eq2} represent current injected into the DC side port nodes (P, N, and O) from all port branches on the AC side in different connection cases. Equivalent sub-circuits 2 to n are similar to the equivalent sub-circuit 1. Values corresponding to R_{eqi}, J_{eq1}, J_{eq2}, and the switch Sᵢ (i=1, 2, . . . , or n) may be given in a form of a switch table, and a specific table structure is shown in Table 1.

In step 200, discretization processing is performed on the equivalent circuit, to obtain an equivalent target circuit, and the equivalent target circuit is a discretized equivalent circuit.

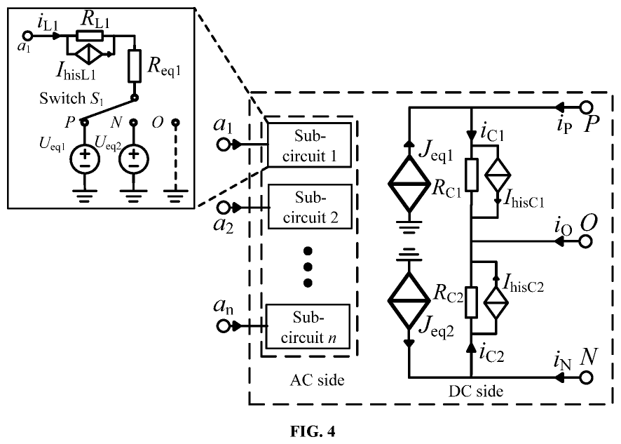

The equivalent circuit shown in FIG. 3 is discretized, that is, both a port inductor and a port capacitor in the equivalent circuit are converted into a form of an admittance parallel current source, to obtain the equivalent target circuit shown in FIG. 4.

R_{Li} is a corresponding conductance after a port inductor in an equivalent sub-circuit on the AC side is discretized, I_{hisLi}^{t-1} is a corresponding historical current source after the port inductor in the equivalent sub-circuit on the AC side is discretized at a moment t−1, R_{C1} and R_{C2} are corresponding conductances after a first port capacitor and a second port capacitor on the DC side are discretized, and I_{hisC1}^{t-1} and I_{hisC2}^{t-1} are respectively corresponding historical current sources after the first port capacitor and the second port capacitor on the DC side are discretized at the moment t−1. When different integration methods are used for discretization, only expressions of the conductances R_{Li}, R_{C1}, and R_{C2} and expressions of the historical current sources I_{hisLi}^{t-1}, I_{hisC1}^{t-1}, and I_{hisC2}^{t-1} need to be changed.

In step 300, a node admittance matrix expression and a historical current source expression are determined according to the equivalent target circuit.

When electromagnetic transient simulation is performed according to a node voltage method, a multi-port Norton equivalent model of the VSC needs to be obtained, that is,

I^{t}=G^{t}U^{t}−Iₕᵢₛ^{t-1} (1)
where superscripts t and t−1 respectively represent a current moment t and a previous moment t−1. A vector I^{t} is a current vector of an external port node, a vector U^{t} is a voltage vector of the external port node, a matrix G^{t} is a corresponding node admittance matrix of the VSC when an external port is a node, and a vector Iₕᵢₛ^{t-1} is a historical current source injected into the external port node from a historical current source inside the VSC.

For the formula (1), when the AC side of the VSC has n branches, the node admittance matrix G^{t} has a dimension of (n+3)×(n+3), and the voltage vector U^{t}, the current vector I^{t}, and the current vector Iₕᵢₛ^{t-1} have a dimension of n+3. The formula (1) may be split into the following form to form element values of related matrix and column vectors:

$${I}_{n}^{t} = {\sum }_{i = 0}^{n} ( {G}_{i}^{t} ) {U}^{t} - {\sum }_{i = 0}^{n} ( {I}_{hisi}^{t - 1} ) . \qquad ( 2 )$$

To form the node admittance matrix G^{t}, the historical current source is first open circuited, then an AC side port node i is connected to a unit voltage source, and the other AC side port nodes are all short circuited and grounded. Various elements of the node admittance matrix are obtained according to a value of current flowing into the AC side port nodes, and then the impact of all branches on the node admittance matrix are superimposed, to finally obtain a complete node admittance matrix. For admittance of the AC side, only admittance of each equivalent sub-circuit in FIG. 4 is considered. For self-admittance of the DC side, both admittance related to a capacitor branch on the DC side and mutual-admittance generated by various equivalent sub-circuits on the AC side are considered.

The node admittance matrix at the current moment t is G^{t}=G₀^{t}+G₁^{t}+ . . . +Gᵢ^{t}+ . . . +Gₙ^{t}, where
G₀^{t} represents self-admittance and mutual-admittance generated by interaction between capacitor branches on the DC side at the current moment.

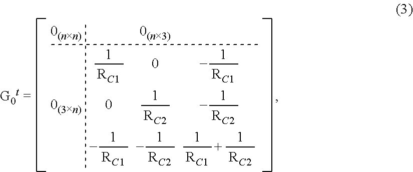

where Gᵢ^{t} represents self-admittance and mutual-admittance generated by interaction between the AC side port node i and the DC side port nodes P, N, and O at the current moment, i=1, 2, . . . , or n, t represents the current moment, and t−1 represents the previous moment.

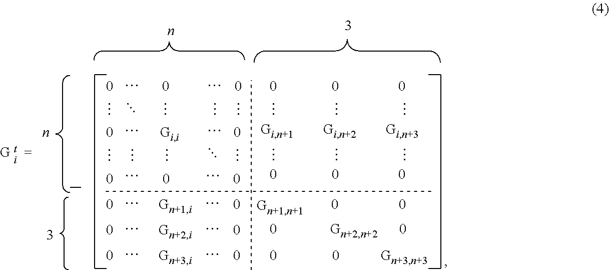

where

$${G}_{i , i} = \frac{1}{{R}_{L i} + {R}_{eqi}} ,$$

$${G}_{n + 1 , n + 1} = \frac{{k}_{i - 1}^{2}}{{R}_{L i} + {R}_{e q i}} ,$$

$${G}_{n + 2 , n + 2} = \frac{{k}_{i - 2}^{2}}{{R}_{L i} + {R}_{e q i}} ,$$

$${G}_{i , n + 1} = {G}_{n + 1 , i} = - \frac{{k}_{i - 1}}{{R}_{L i} + {R}_{e q i}} ,$$

$${G}_{i , n + 2} = {G}_{n + 2 , i} = - \frac{{k}_{i - 2}}{{R}_{L i} + {R}_{e q i}} ,$$

$${G}_{i , n + 3} = {G}_{n + 3 , i} = 0 ,$$

$$and {G}_{n + 3 , n + 3} = 0.$$

kᵢ₋₁ and kᵢ₋₂ are coefficients related to switch combinations in an i^{th} AC side branch, R_{Li} is a corresponding conductance after a port inductor in an i^{th} AC side equivalent sub-circuit is discretized, and R_{eqi} is a total resistance when the i^{th} AC side equivalent sub-circuit is turned on.

Finally, the foregoing formulas may be accumulated to obtain G^{t}:

$${G}^{t} = {\sum }_{i = 0}^{n} {G}_{i}^{t} . \qquad ( 5 )$$

The historical current source injected into the DC side port nodes P, N, and O and the AC side port nodes a₁, a₂, . . . , and aₙ is Iₕᵢₛ^{t-1}=Iₕᵢₛ₀^{t-1}+Iₕᵢₛ₁^{t-1}+ . . . +Iₕᵢₛᵢ^{t-1}+ . . . +Iₕᵢₛₙ^{t-1},
where Iₕᵢₛ₀^{t-1} represents a current injected into various nodes from historical current sources generated by all capacitor branches on the DC side at the previous moment.

$${I}_{his 0}^{t - 1} = [ \begin{matrix}⋮ \\ 0 \\ ⋮ \\ - {I}_{his C 1} \\ - {I}_{his C 2} \\ {I}_{his C 1} + {I}_{his C 2}\end{matrix} ] , \qquad ( 6 )$$

where Iₕᵢₛᵢ^{t-1} represents a current injected into various port nodes from a historical current source generated by an i^{th} inductor branch on the AC side at the previous moment.

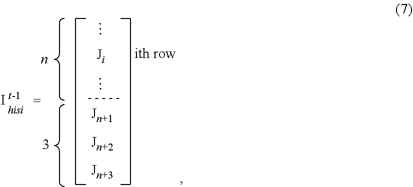

where

$${J}_{i} = - ( \frac{{R}_{L i}}{{R}_{L i} + {R}_{e q i}} ) {I}_{hisLi}^{t - 1} ,$$

$${J}_{n + 1} = ( \frac{{k}_{i - 1} {R}_{L i}}{{R}_{L i} + {R}_{e q i}} ) {I}_{hisLi}^{t - 1} ,$$

$${J}_{n + 2} = ( \frac{{k}_{i - 2} {R}_{L i}}{{R}_{L i} + {R}_{e q i}} ) {I}_{hisLi}^{t - 1} ,$$

$${J}_{n + 3} = 0 ,$$

$$and {I}_{his Li}^{t - 1}$$

is a corresponding historical current source after the port inductor on the i^{th} AC side equivalent sub-circuit at the previous moment is discretized.

Finally, the foregoing formulas may be accumulated to obtain Iₕᵢₛᵢ^{t-1}:

$${I}_{his}^{t - 1} = {\sum }_{i = 0}^{n} {I}_{hisi}^{t - 1} . \qquad ( 8 )$$

The foregoing conductance and historical current source have different expressions when different integration methods are used, as shown in the following:
(1) When trapezoidal integration is adopted, the following relationships exist, where h is a corresponding integration step. When a switch Sᵢ selects u_{P}, U_{eqi}=u_{P}, and when Sᵢ selects u_{N}, U_{eqi}=u_{N}.

$${R}_{L i} = \frac{2 {L}_{1}}{h} , \qquad ( 9 )$$

$${I}_{hisLi}^{t - 1} = {i}_{L i}^{t - 1} + \frac{{u}_{i}^{t - 1} - ( {U}_{e q i}^{t - 1} + {i}_{L i}^{t - 1} {R}_{o n} )}{{R}_{L i}}$$

$${R}_{C 1} = \frac{h}{2 {C}_{1}} ,$$

$${I}_{his C 1}^{t - 1} = - {i}_{C 1}^{t - 1} - \frac{{u}_{P}^{t - 1} - {u}_{O}^{t - 1}}{{R}_{C 1}} = - {i}_{P}^{t - 1} - {J}_{e q 1}^{t - 1} - \frac{{u}_{P}^{t - 1} - {u}_{O}^{t - 1}}{{R}_{C 1}}$$

$${R}_{C 2} = \frac{h}{2 {C}_{2}} ,$$

$${I}_{his C 2}^{t - 1} = - {i}_{C 2}^{t - 1} - \frac{{u}_{N}^{t - 1} - {u}_{O}^{t - 1}}{{R}_{C 2}} = - {i}_{N}^{t - 1} - {J}_{e q 2}^{t - 1} - \frac{{u}_{N}^{t - 1} - {u}_{O}^{t - 1}}{{R}_{C 2}} ,$$

(2) When backward Euler integration is adopted, the following relationships exist:

$${R}_{L i} = \frac{{L}_{1}}{h} , {I}_{hisLi}^{t - 1} = {i}_{Li}^{t - 1} \qquad ( 10 )$$

$${R}_{C 1} = \frac{h}{{C}_{1}} , {I}_{his C 1}^{t - 1} = - \frac{{u}_{P}^{t - 1} - {u}_{O}^{t - 1}}{{R}_{C 1}}$$

$${R}_{C 2} = \frac{h}{{C}_{2}} , {I}_{his C 2}^{t - 1} = - \frac{{u}_{N}^{t - 1} - {u}_{O}^{t - 1}}{{R}_{C 2}} .$$

(3) When damping coefficient integration is adopted, the following relationships exist:

$${R}_{L i} = \frac{2 {L}_{i}}{h ( 1 + α )} , \qquad ( 11 )$$

$${I}_{hisLi}^{t - 1} = {i}_{L i}^{t - 1} + h ( 1 - α ) \frac{{u}_{i}^{t - 1} - ( {U}_{e q i}^{t - 1} + {i}_{L i}^{t - 1} {R}_{o n} )}{2 {L}_{i}}$$

$${R}_{C 1} = \frac{h ( 1 + α )}{2 {C}_{1}} ,$$

$${I}_{his C 1}^{t - 1} = - \frac{1 - α}{1 + α} {i}_{C 1}^{t - 1} - \frac{{u}_{P}^{t - 1} - {u}_{O}^{t - 1}}{{R}_{C 1}} = - \frac{1 - α}{1 + α} ( {i}_{P}^{t - 1} + {J}_{e q 1}^{t - 1} ) - \frac{{u}_{P}^{t - 1} - {u}_{O}^{t - 1}}{{R}_{C 1}}$$

$${R}_{C 2} = \frac{h ( 1 + α )}{2 {C}_{2}} ,$$

$${I}_{his C 2}^{t - 1} = - \frac{1 - α}{1 + α} {i}_{C 2}^{t - 1} - \frac{{u}_{N}^{t - 1} - {u}_{O}^{t - 1}}{{R}_{C 2}} = - \frac{1 - α}{1 + α} ( {i}_{N}^{t - 1} - {J}_{e q 2}^{t - 1} ) - \frac{{u}_{N}^{t - 1} - {u}_{O}^{t - 1}}{{R}_{C 2}} ,$$

where α is a corresponding damping coefficient, a value range of α is [0, 1], when α is 0, the trapezoidal integration method is adopted, and when α is 1, the backward Euler integration method is adopted.

When different integration methods are selected, the formula (9), the formula (10), or the formula (11) may be respectively substituted into the corresponding node admittance matrix and historical current source, to obtain a specific expression.

According to the above derivation, parameters in the node admittance matrix G^{t} and the historical current source Iₕᵢₛ^{t-1} may be obtained according to different switch combinations in a switch table. A general switch table form is given with a switch table corresponding to the i^{th} equivalent sub-circuit as an example.

TABLE 1
Switch table corresponding to an i^{th} equivalent sub-circuit

| | | | | | |
|---|---|---|---|---|---|
| | | | | Corrected | Corrected |
| | | | | elements | elements |
| Tᵢ | Sᵢ | kᵢ | R_{eqi} | in G^{t} | in Iₕᵢₛ^{t-1} |

Switch combination 1
. . .
Switch combination n

When the equivalent switch S1 is connected to the DC side port node P, elements to be corrected in G^{t} are G_{i,i}, G_{i,n+1}, G_{n+1,i}, and G_{n+1,n+1}, elements to be corrected in Iₕᵢₛ^{t-1} are Jᵢ and Jₙ₊₁. When the equivalent switch Sᵢ is connected to the DC side port node N, the elements to be corrected in G^{t} are G_{i,i}, G_{i,n+2}, G_{i,n+2}, and G_{n+2,n+2}, and the elements to be corrected in Iₕᵢₛ^{t-1} are Jᵢ and Jₙ₊₂. When the equivalent switch Sᵢ is connected to the DC side port node O, the elements to be corrected in G′ are G_{i,i}, G_{i,n+3}, G_{n+3,i}, and G_{n+3,n+3}, and the elements to be corrected in Iₕᵢₛ^{t-1} are Jᵢ and Jₙ₊₃.

In step 400, a multi-port Norton equivalent model corresponding to the VSC is constructed according to the node admittance matrix expression and the historical current source expression.

An expression of the multi-port Norton equivalent model is I^{t}=G^{t}U^{t}−Iₕᵢₛ^{t-1} (1), where t represents a current moment, t−1 represents a previous moment, Iₕᵢₛ^{t} represents a port node current at the current moment, G^{t} represents a node admittance matrix at the current moment, U^{t} represents a port node voltage at the current moment, and Iₕᵢₛ^{t-1} represents a historical current source at the previous moment.

In step 500, electromagnetic transient simulation is performed on the VSC by using the multi-port Norton equivalent model, to obtain a simulation result.

The step specifically includes: performing electromagnetic transient simulation on the VSC according to the multi-port Norton equivalent model by using a node voltage method, to obtain the simulation result.

Further, a node admittance matrix at the current moment and a historical current source at the previous moment are first obtained. A port node voltage at the current moment is calculated according to the node admittance matrix at the current moment and the historical current source at the previous moment. Then a port node current at the current moment is obtained according to the node admittance matrix at the current moment, the historical current source at the previous moment, the port node voltage at the current moment, and the multi-port Norton equivalent model, the node admittance matrix at the current moment and the historical current source at the previous moment are updated, and in a return step, a port node voltage at the current moment is calculated according to the node admittance matrix at the current moment and the historical current source at the previous moment is returned until simulation is finished.

In an example, as shown in FIG. 5, after G^{t} at the current moment t and the historical current value at the previous moment t−1 are obtained, the VSC may be added to an external system by using the formula (1) to participate in simulative solution of the entire system at the moment t. Then after the external system obtains U^{t} at the moment t, a port node current I^{t} at the moment t may be calculated by using the formula (1) according to the historical current source of the VSC at the moment t. Finally, the admittance matrix G^{t+1} and the historical current source Iₕᵢₛ^{t} are updated by using the formula (5) and the formula (8). Subsequently, the foregoing steps are repeated, to complete the solution of the entire simulation period.

Examples of specific application objects:
(1) Half-bridge (half-bridge, HB) circuit

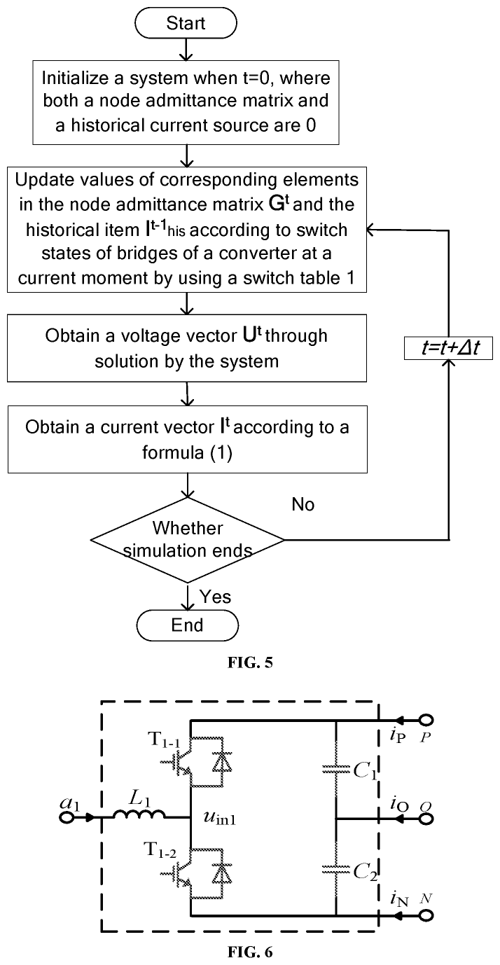

FIG. 6 is a topology diagram of a half-bridge circuit according to the present disclosure. FIG. 7 is a diagram of an equivalent circuit corresponding to a half-bridge circuit according to the present disclosure.

$$\{ \begin{matrix}{U}_{e q 1} = {k}_{1 - 1} {u}_{P} + {k}_{1 - 2} {u}_{N} \\ {J}_{e q 1} = {k}_{1 - 1} {i}_{L 1} \\ {J}_{e q 2} = {k}_{1 - 2} {i}_{L 1}\end{matrix} , \qquad ( 12 )$$

$$( \begin{matrix}\begin{matrix}{I}_{his L 1}^{t - 1} = {i}_{L 1}^{t - 1} + \frac{1}{{R}_{L 1}} ( {u}_{a 1}^{t - 1} - {U}_{eq 1}^{t - 1} - {R}_{eq 1} {i}_{L 1}^{t - 1} ) \\ {I}_{his C 1}^{t - 1} = - ( {i}_{P}^{t - 1} + {J}_{eq 1}^{t - 1} ) - \frac{{u}_{P}^{t - 1} - {u}_{O}^{t - 1}}{{R}_{C 1}}\end{matrix} \\ {I}_{his C 2}^{t - 1} = - ( {i}_{N}^{t - 1} + {J}_{eq 2}^{t - 1} ) - \frac{{u}_{N}^{t - 1} - {u}_{O}^{t - 1}}{{R}_{C 2}}\end{matrix} , \qquad ( 13 )$$

the node admittance matrix G^{t} and the historical current source Iₕᵢₛ^{t-1} may be accumulated into

G^{t}=G₀^{t}+G₁^{t}

Iₕᵢₛ^{t-1}=Iₕᵢₛ₀^{t-1}+Iₕᵢₛ₁^{t-1}. (14)

A switch state is shown in Table 2.

TABLE 2
Half-bridge circuit switch state table

| | | | | | | Corrected | Corrected |
|---|---|---|---|---|---|---|---|
| Tᵢ₋₁ | Tᵢ₋₂ | Sᵢ | kᵢ₋₁ | kᵢ₋₂ | R_{eqi} | elements in G | elements in Iₕᵢₛ |
| 1 | 0 | u_{P} | 1 | 0 | Rₒₙ | G_{i, i}, G_{i, 2}, G_{2, i}, | J₁, J₂ |
| | | | | | | G_{2, 2} | |
| 0 | 1 | u_{N} | 0 | 1 | Rₒₙ | G_{i, i}, G_{i, 3}, G_{3, i}, | J₁, J₃ |
| | | | | | | G_{3, 3} | |

A value of i is 1, Sᵢ column represents a voltage of a connection point of the switch Sᵢ in the equivalent circuit, kᵢ₋₁ and kᵢ₋₂ are calculation coefficients in U_{eq} and J_{eq}, R_{eqi} is an input resistance on the AC side in the equivalent circuit, and subscripts of elements in columns where the corrected elements in G and the corrected elements in his are located represent the number of rows and the number of columns of corrected elements to be corrected.
(2) H-bridge (h-bridge) circuit/full-bridge circuit

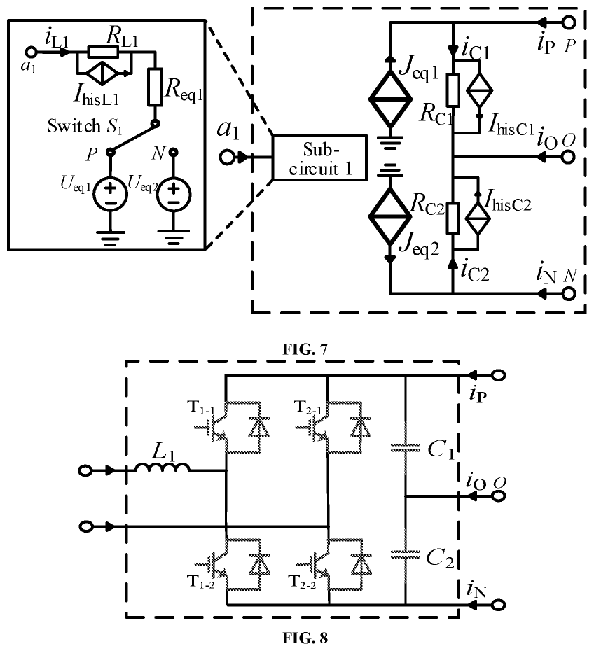

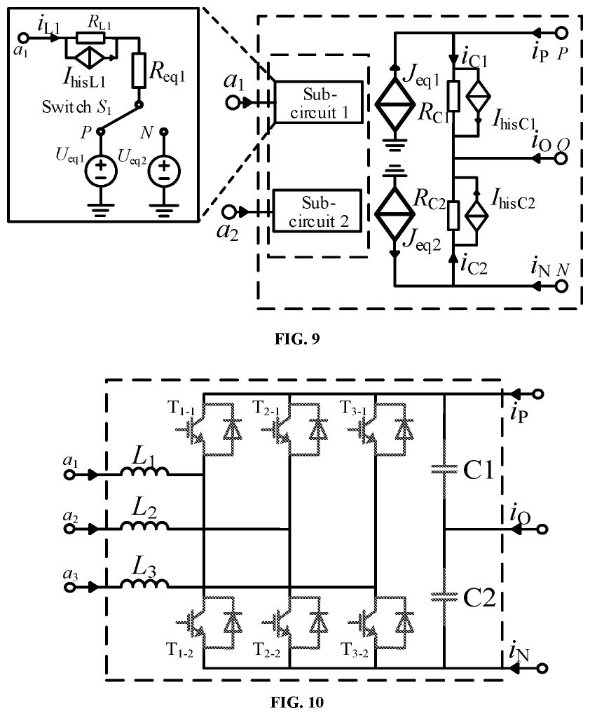

FIG. 8 is a topology diagram of an H-bridge circuit according to the present disclosure. FIG. 9 is a diagram of an equivalent circuit corresponding to an H-bridge circuit according to the present disclosure. Because only the inductor L₁ exists on the AC side in an actual H-bridge circuit, in order to model by using a common modeling formula, it is assumed that an inductor L₂ exists on the AC side during the modeling, and a number of elements related to Leis set to 0 during calculation, that is, R_{L2}=0, and I_{hisL2}=0.

$$\{ \begin{matrix}{U}_{e q 1} = {k}_{1 - 1} {u}_{P} + {k}_{1 - 2} {u}_{N} \\ {J}_{e q 1} = {k}_{1 - 1} {i}_{L 1} + {k}_{1 - 2} {i}_{L 2} \\ {U}_{e q 2} = {k}_{2 - 1} {u}_{P} + {k}_{2 - 2} {u}_{N} \\ {J}_{e q 2} = {k}_{2 - 1} {i}_{L 1} + {k}_{2 - 2} {i}_{L 2}\end{matrix} , \qquad ( 15 )$$

$$\{ \begin{matrix}\begin{matrix}{I}_{his L 1}^{t - 1} = {i}_{L 1}^{t - 1} + \frac{1}{{R}_{L 1}} ( {u}_{a 1}^{t - 1} - {U}_{e q 1}^{t - 1} - {R}_{e q 1} {i}_{L 1}^{t - 1} ) \\ {I}_{his L 2}^{t - 1} = 0 \\ {I}_{his C 1}^{t - 1} = - ( {i}_{P}^{t - 1} + {J}_{e q 1}^{t - 1} ) - \frac{{u}_{P}^{t - 1} - {u}_{O}^{t - 1}}{{R}_{C 1}}\end{matrix} \\ {I}_{his C 2}^{t - 1} = - ( {i}_{N}^{t - 1} + {J}_{e q 2}^{t - 1} ) - \frac{{u}_{N}^{t - 1} - {u}_{O}^{t - 1}}{{R}_{C 2}}\end{matrix} , \qquad ( 16 )$$

the node admittance matrix G^{t} and the historical current source Iₕᵢₛ^{t-1} may be accumulated into

G^{t}=G₀^{t}+G₁^{t}+G₂^{t}

Iₕᵢₛ^{t-1}=Iₕᵢₛ₀^{t-1}+Iₕᵢₛ₁^{t-1}+Iₕᵢₛ₂^{t-1}. (17)

Because the switch state is simplified, a result is shown in Table 3

TABLE 3
H-bridge circuit switch state table

| | | | | | | Corrected | Corrected |
|---|---|---|---|---|---|---|---|
| Tᵢ₋₁ | Tᵢ₋₂ | Sᵢ | kᵢ₋₁ | kᵢ₋₂ | R_{eqi} | elements in G | elements in Iₕᵢₛ |
| 1 | 0 | u_{P} | 1 | 0 | Rₒₙ | G_{i, i}, G_{i, 3}, G_{3, i}, | Jᵢ, J₃ |
| | | | | | | G_{3, 3} | |
| 0 | 1 | u_{N} | 0 | 1 | Rₒₙ | G_{i, i}, G_{i, 4}, G_{4, i}, | Jᵢ, J₄ |
| | | | | | | G_{4, 4} | |

Values of i are respectively 1 and 2, and definitions of the remaining elements are the same as the foregoing.
(3) VSC (Voltage source converter) three-phase circuit

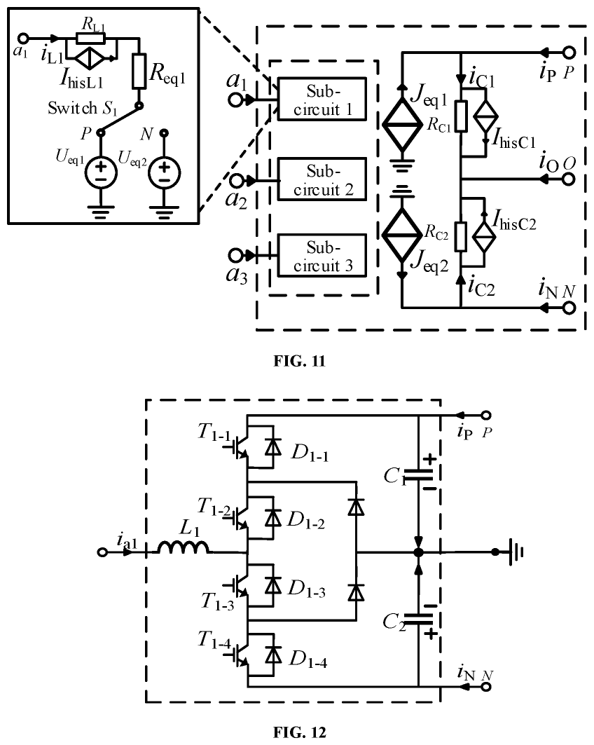

FIG. 10 is a topology diagram of a VSC three-phase circuit according to the present disclosure. FIG. 11 is a diagram of an equivalent circuit corresponding to a VSC three-phase circuit according to the present disclosure,

$$\{ \begin{matrix}{U}_{e q 1} = {k}_{1 - 1} {u}_{P} + {k}_{1 - 2} {u}_{N} \\ {J}_{e q 1} = {k}_{1 - 1} {i}_{L 1} + {k}_{2 - 1} {i}_{L 2} + {k}_{3 - 1} {i}_{L 3} \\ {U}_{e q 2} = {k}_{2 - 1} {u}_{P} + {k}_{2 - 2} {u}_{N} \\ {J}_{e q 2} = {k}_{1 - 2} {i}_{L 1} + {k}_{2 - 2} {i}_{L 2} + {k}_{3 - 2} {i}_{L 3} \\ {U}_{e q 3} = {k}_{3 - 1} {u}_{P} + {k}_{3 - 2} {u}_{N}\end{matrix} , \qquad ( 18 )$$

$$( \begin{matrix}\begin{matrix}\begin{matrix}\begin{matrix}{I}_{his L 1}^{t - 1} = {i}_{L 1}^{t - 1} + \frac{1}{{R}_{L 1}} ( {u}_{a 1}^{t - 1} - {U}_{e q 1}^{t - 1} - {R}_{e q 1} {i}_{L 1}^{t - 1} ) \\ {I}_{his L 2}^{t - 1} = {i}_{L 2}^{t - 1} + \frac{1}{{R}_{L 2}} ( {u}_{a 2}^{t - 1} - {U}_{eq 2}^{t - 1} - {R}_{eq 2} {i}_{L 2}^{t - 1} )\end{matrix} \\ {I}_{his L 3}^{t - 1} = {i}_{L 3}^{t - 1} + \frac{1}{{R}_{L 3}} ( {u}_{a 3}^{t - 1} - {U}_{eq 3}^{t - 1} - {R}_{eq 3} {i}_{L 3}^{t - 1} )\end{matrix} \\ {I}_{his C 1}^{t - 1} = - ( {i}_{P}^{t - 1} + {J}_{e q 1}^{t - 1} ) - \frac{{u}_{P}^{t - 1} - {u}_{O}^{t - 1}}{{R}_{C 1}}\end{matrix} \\ {I}_{his C 2}^{t - 1} = - ( {i}_{N}^{t - 1} + {J}_{eq 2}^{t - 1} ) - \frac{{u}_{N}^{t - 1} - {u}_{O}^{t - 1}}{{R}_{C 2}}\end{matrix} , \qquad ( 19 )$$

and the node admittance matrix G^{t} and the historical current source Iₕᵢₛ^{t-1} may be accumulated into

G^{t}=G₀^{t}+G₁^{t}+G₂^{t}+G₃^{t}

Iₕᵢₛ^{t-1}=Iₕᵢₛ₀^{t-1}+Iₕᵢₛ₁^{t-1}+Iₕᵢₛ₂^{t-1}+Iₕᵢₛ₃^{t-1}. (20)

Because the switch state is simplified, results are shown in Table 4

TABLE 4
VSC three-phase circuit switch state table

| | | | | | | Corrected | Corrected |
|---|---|---|---|---|---|---|---|
| Tᵢ₋₁ | Tᵢ₋₂ | Sᵢ | kᵢ₋₁ | kᵢ₋₂ | R_{eqi} | elements in G | elements in Iₕᵢₛ |
| 1 | 0 | u_{P} | 1 | 0 | Rₒₙ | G_{i, i}, G_{i, 3}, G_{3, i}, | Jᵢ, J₃ |
| | | | | | | G_{3, 3} | |
| 0 | 1 | u_{N} | 0 | 1 | Rₒₙ | G_{i, i}, G_{i, 4}, G_{4, i}, | Jᵢ, J₄ |
| | | | | | | G_{4, 4} | |

Values of i are respectively 1, 2, and 3, and definitions of the remaining elements are the same as the foregoing.
(4) NPC three-level VSC model

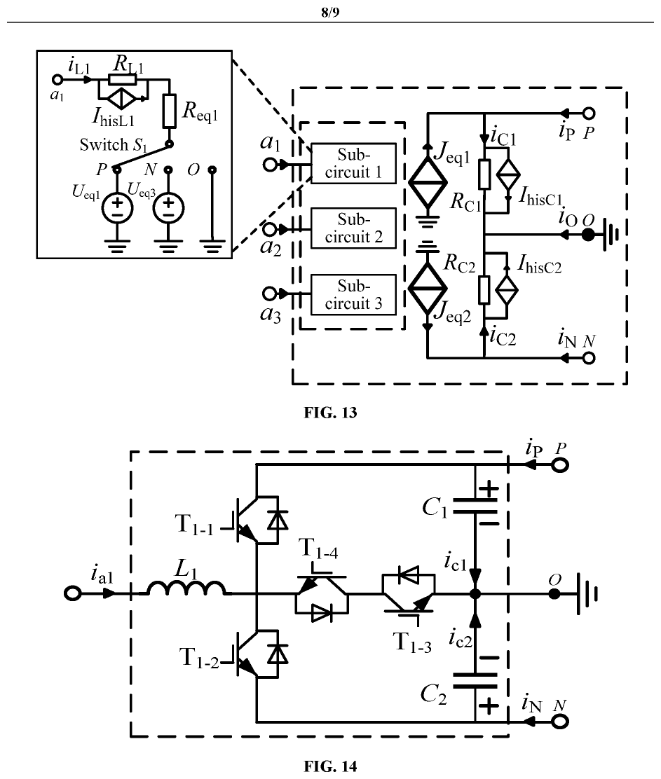

An AC side of the NPC three-level VSC model is a three-phase circuit. Only one phase is drawn in an original circuit for description, and other two-phase original circuit are the same as the first phase. As shown in FIG. 12 and FIG. 13, calculation formulas of parameters R_{eq1}, U_{eq1}, J_{eq1}, and J_{eq2} are the same as the formula (12), calculation formulas of historical current sources I_{hisL1}, I_{hisC1}, and I_{hisC2} are the same as the formula (13), and calculation formulas of a node admittance matrix and a historical current source are the same as the formula (14). Because the switch state is simplified, results are shown in Table 5

TABLE 5
NPC three-level VSC equivalent circuit parameter table

| | | | | | | | | | | Corrected | Corrected |
|---|---|---|---|---|---|---|---|---|---|---|---|
| | | | | | | | | | | elements | elements |
| Tᵢ₋₁ | Tᵢ₋₂ | Tᵢ₋₃ | Tᵢ₋₄ | Dᵢ₋₅ | Dᵢ₋₆ | Sᵢ | kᵢ₋₁ | kᵢ₋₂ | R_{eqi} | in G | in Iₕᵢₛ |
| 1 | 1 | 0 | 0 | 0 | 0 | u_{P} | 1 | 0 | 2Rₒₙ | G_{i, i}, G_{i, 4}, | Jᵢ, J₄ |
| | | | | | | | | | | G_{4, i}, G_{4, 4} | |
| 0 | 1 | 0 | 0 | 1 | 0 | u_{O} | 0 | 0 | 2Rₒₙ | G_{i, i}, G_{i, 6}, | Jᵢ, J₆ |
| | | | | | | | | | | G_{6, i}, G_{6, 6} | |
| 0 | 0 | 1 | 1 | 0 | 0 | u_{N} | 0 | 1 | 2Rₒₙ | G_{i, i}, G_{i, 5}, | Jᵢ, J₅ |
| | | | | | | | | | | G_{5, i}, G_{5, 5} | |
| 0 | 0 | 1 | 0 | 0 | 1 | u_{O} | 0 | 0 | 2Rₒₙ | G_{i, i}, G_{i, 6}, | Jᵢ, J₆ |
| | | | | | | | | | | G_{6, i}, G_{6, 6} | |
| 1 | 1 | 0 | 0 | 0 | 0 | u_{N} | 1 | 0 | 2Rₒₙ | G_{i, i}, G_{i, 5}, | Jᵢ, J₅ |
| | | | | | | | | | | G_{5, i}, G_{5, 5} | |
| 0 | 0 | 1 | 1 | 0 | 0 | u_{P} | 0 | 1 | 2Rₒₙ | G_{i, i}, G_{i, 4}, | Jᵢ, J₄ |
| | | | | | | | | | | G_{4, i}, G_{4, 4} | |

Values of i are respectively 1, 2, and 3, and definitions of the remaining elements are the same as the foregoing.
(5) T-type three-level VSC model

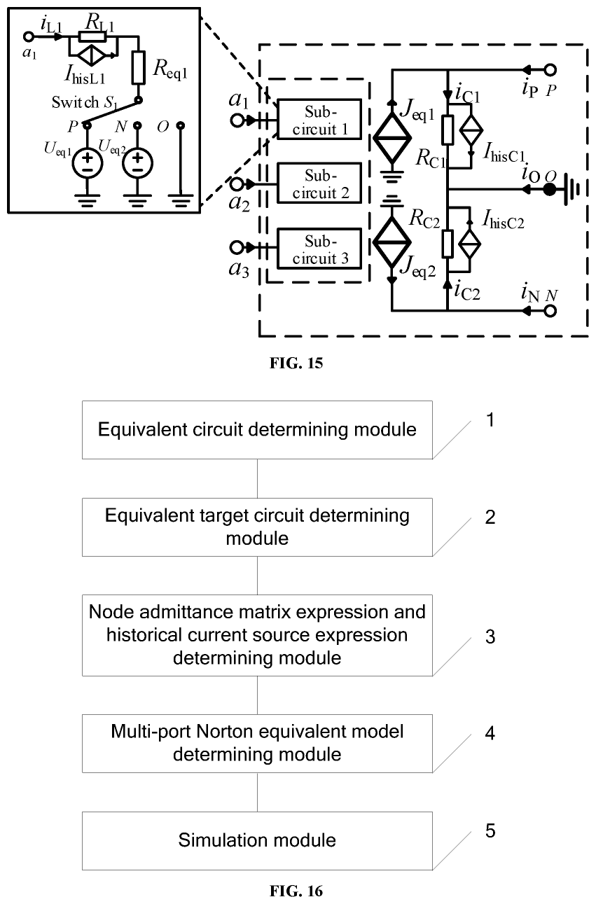

An AC side of the T-type three-level VSC model is a three-phase circuit. Only one phase is drawn in an original circuit for description, and other two-phase original circuit are the same as the first phase. As shown in FIG. 14 and FIG. 15, calculation formulas of parameters R_{eq1}, U_{eq1}, J_{eq1}, and J_{eq2} are the same as the formula (12), calculation formulas of historical current sources I_{hisL1}, I_{hisC1}, and I_{hisC2} are the same as the formula (13), and calculation formulas of a node admittance matrix and a historical current source are the same as the formula (14). Because the switch state is simplified, results are shown in Table 6

TABLE 6
Single-phase three-level VSC equivalent circuit parameter table

| | | | | | | | | Corrected | Corrected |
|---|---|---|---|---|---|---|---|---|---|
| | | | | | | | | elements | elements in |
| Tᵢ₋₁ | Tᵢ₋₂ | Tᵢ₋₃ | Tᵢ₋₄ | Sᵢ | kᵢ₋₁ | kᵢ₋₂ | R_{eqi} | in G | Iₕᵢₛ |
| 1 | 0 | 0 | 0 | u_{P} | 1 | 0 | Rₒₙ | G_{i, i}, G_{i, 4}, | Jᵢ, J₄ |
| | | | | | | | | G_{4, i}, G_{4, 4} | |
| 0 | 0 | 0 | 1 | u_{O} | 0 | 0 | 2Rₒₙ | G_{i, i}, G_{i, 6}, | Jᵢ, J₆ |
| | | | | | | | | G_{6, i}, G_{6, 6} | |
| 0 | 1 | 0 | 0 | u_{N} | 0 | 1 | Rₒₙ | G_{i, i}, G_{i, 5}, | Jᵢ, J₅ |
| | | | | | | | | G_{5, i}, G_{5, 5} | |
| 0 | 0 | 1 | 0 | u_{O} | 0 | 0 | 2Rₒₙ | G_{i, i}, G_{i, 6}, | Jᵢ, J₆ |
| | | | | | | | | G_{6, i}, G_{6, 6} | |
| 1 | 0 | 0 | 0 | u_{P} | 1 | 0 | Rₒₙ | G_{i, i}, G_{i, 4}, | Jᵢ, J₄ |
| | | | | | | | | G_{4, i}, G_{4, 4} | |
| 0 | 1 | 0 | 0 | u_{N} | 0 | 1 | Rₒₙ | G_{i, i}, G_{i, 5}, | Jᵢ, J₅ |
| | | | | | | | | G_{5, i}, G_{5, 5} | |

### Embodiment 2

To perform the method corresponding to Embodiment 1 and implement the corresponding functions and technical effects, the following provides an electromagnetic transient simulation apparatus for a VSC.

As shown in FIG. 16, the electromagnetic transient simulation apparatus for a VSC includes:
an equivalent circuit determining module 1, configured to perform circuit equivalence processing on a VSC with any number of ports based on a work mechanism of the VSC, to obtain an equivalent circuit corresponding to the VSC, where the work mechanism is a mechanism in which an inductor open circuit and a capacitor short circuit are not allowed inside the VSC during normal operation; the equivalent circuit includes a DC side and an AC side; the DC side includes three DC side port nodes, two port capacitors, and two controlled current sources, where a first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the controlled current sources are current injected into the DC side port nodes from all port branches of the AC side; and the AC side includes one or more equivalent sub-circuits with separately represented DC sides and AC sides, and the equivalent sub-circuit includes one AC side port node, one port inductor, one total resistor, and one switch, where the AC side port node is connected to one end of the switch sequentially by the port inductor and the total resistor, and the other end of the switch is configured to connect any one of the DC side port nodes, and the total resistor represents a total resistor when the equivalent sub-circuit is turned on;
an equivalent target circuit determining module 2, configured to perform discretization processing on the equivalent circuit, to obtain an equivalent target circuit, where the equivalent target circuit is a discretized equivalent circuit;
a node admittance matrix expression and historical current source expression determining module 3, configured to determine a node admittance matrix expression and a historical current source expression according to the equivalent target circuit;
a multi-port Norton equivalent model determining module 4, configured to construct a multi-port Norton equivalent model corresponding to the VSC according to the node admittance matrix expression and the historical current source expression; and
a simulation module 5, configured to perform electromagnetic transient simulation on the VSC by using the multi-port Norton equivalent model, to obtain a simulation result.

### Embodiment 3

An embodiment of the present disclosure provides an electronic device, including a memory and a processor, where the memory is configured to store a computer program, and the processor executes the computer program to cause the electronic device to perform the VSC electromagnetic transient simulation method in Embodiment 1.

Optionally, the electronic device may be a server.

In addition, an embodiment of the present disclosure further provides a computer-readable storage medium storing a computer program, the computer program implements the VSC electromagnetic transient simulation method in Embodiment 1 when being executed by a processor.

Each embodiment of the present specification is described in a progressive manner, each embodiment focuses on the differences from other embodiments, and the same and similar parts between the embodiments may refer to each other. Since the system disclosed in the embodiment corresponds to the method disclosed in another embodiment, the description is relatively simple, and reference can be made to the method description.

Specific examples are used herein to explain the principles and implementations of the present disclosure. The foregoing description of the embodiments is merely intended to help understand the method and the core idea of the present disclosure; besides, various modifications may be made by a person of ordinary skill in the art to specific implementations and the scope of application in accordance with the ideas of the present disclosure. In conclusion, the content of the present specification shall not be construed as limitations to the present disclosure.

What is claimed is:

1. An electromagnetic transient simulation method for a voltage source converter (VSC), comprising:
performing circuit equivalence processing on a VSC with any number of ports based on a work mechanism of the VSC, to obtain an equivalent circuit corresponding to the VSC, wherein the work mechanism is a mechanism in which an inductor open circuit and a capacitor short circuit are not allowed inside the VSC during normal operation, the equivalent circuit comprises a direct current (DC) side and an alternating current (AC) side, the DC side comprises three DC side port nodes, two port capacitors, and two controlled current sources, wherein a first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the first controlled current source and the second controlled current source are current injected into to the DC side port nodes from all port branches of the AC side; and the AC side comprises one or more equivalent sub-circuits with separately represented DC sides and AC sides, and the equivalent sub-circuit comprises one AC side port node, one port inductor, one total resistor, and one switch, wherein the AC side port node is connected to one end of the switch sequentially by the port inductor and the total resistor, and the other end of the switch is configured to connect any one of the DC side port nodes, and the total resistor represents a total resistor when the equivalent sub-circuit is turned on;
performing discretization processing on the equivalent circuit, to obtain an equivalent target circuit, wherein the equivalent target circuit is a discretized equivalent circuit;
determining a node admittance matrix expression and a historical current source expression according to the equivalent target circuit;
constructing a multi-port Norton equivalent model corresponding to the VSC according to the node admittance matrix expression and the historical current source expression; and
performing electromagnetic transient simulation on the VSC by using the multi-port Norton equivalent model, to obtain a simulation result.

2. The method according to claim 1, wherein the performing discretization processing on the equivalent circuit, to obtain an equivalent target circuit comprises:
converting both a port inductor and a port capacitor in the equivalent circuit into a form of an admittance parallel current source, to obtain the equivalent target circuit.

3. The method according to claim 1, wherein the determining a node admittance matrix expression and a historical current source expression according to the equivalent target circuit comprises:
determining the node admittance matrix expression and the historical current source expression according to the equivalent target circuit and an integration method, wherein the integration method is a trapezoidal integration method, a backward Euler integration method, or a damping coefficient integration method.

4. The method according to claim 1, wherein the node admittance matrix G^{t} expression at a current moment t is
G^{t}=G₀^{t}+G₁^{t}+ . . . +Gᵢ^{t}+ . . . +Gₙ^{t},
and the historical current source Iₕᵢₛ^{t-1} expression at a previous moment t−1 is
Iₕᵢₛ^{t-1}=Iₕᵢₛ₀^{t-1}+Iₕᵢₛ₁^{t-1}+ . . . +Iₕᵢₛᵢ^{t-1}+ . . . +Iₕᵢₛₙ^{t-1},
wherein i=1, 2, . . . , or n; G₀^{t} represents self-admittance and mutual-admittance generated by interaction between capacitor branches on the DC side at the current moment; Gᵢ^{t} represents self-admittance and mutual-admittance generated by interaction between an AC side port node i and the DC side port nodes at the current moment, Iₕᵢₛ₀^{t-1} represents a current injected into various port nodes from a historical current source generated by all capacitor branches on the DC side at a previous moment, and Iₕᵢₛᵢ^{t-1} represents a current injected into various port nodes from a historical current source generated by an i^{th} inductor branch on the AC side at the previous moment;
$${G}_{0}^{t} = [ \begin{matrix}{0}_{( n \times n )} & & {0}_{( n \times 3 )} & \\ & \frac{1}{{R}_{C 1}} & 0 & - \frac{1}{{R}_{C 1}} \\ {0}_{( 3 \times n )} & 0 & \frac{1}{{R}_{C 2}} & - \frac{1}{{R}_{C 2}} \\ & - \frac{1}{{R}_{C 1}} & - \frac{1}{{R}_{C 2}} & \frac{1}{{R}_{C 1}} + \frac{1}{{R}_{C 2}}\end{matrix} ] ,$$
wherein R_{C1} and R_{C2} are respectively corresponding conductances after the first port capacitor and the second port capacitor on the DC side are discretized; and n represents a number of branches of the VSC; 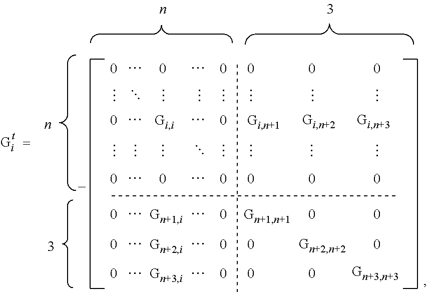
wherein
$${G}_{i , i} = \frac{1}{{R}_{L i} + {R}_{eqi}} ,$$
$${G}_{n + 1 , n + 1} = \frac{{k}_{i - 1}^{2}}{{R}_{L i} + {R}_{e q i}} ,$$
$${G}_{n + 2 , n + 2} = \frac{{k}_{i - 2}^{2}}{{R}_{L i} + {R}_{e q i}} ,$$
$${G}_{i , n + 1} = {G}_{n + 1 , i} = - \frac{{k}_{i - 1}}{{R}_{L i} + {R}_{e q i}} ,$$
$${G}_{i , n + 2} = {G}_{n + 2 , i} = - \frac{{k}_{i - 2}}{{R}_{L i} + {R}_{e q i}} ,$$
$${G}_{i , n + 3} = {G}_{n + 3 , i} = 0 ,$$
$$and {G}_{n + 3 , n + 3} = 0 ,$$
and kᵢ₋₁ and kᵢ₋₂ are coefficients related to switch combinations in an i^{th} AC side branch, R_{Li} is a corresponding conductance after a port inductor in an i^{th} AC side equivalent sub-circuit is discretized, and R_{egi} is a total resistance when the i^{th} AC side equivalent sub-circuit is turned on;
$${I}_{his 0}^{t - 1} = [ \begin{matrix}⋮ \\ 0 \\ ⋮ \\ - {I}_{his C 1} \\ - {I}_{his C 2} \\ {I}_{his C 1} + {I}_{his C 2}\end{matrix} ] ,$$
wherein I_{hisC1}^{t-1} and I_{hisC2}^{t-2} are respectively corresponding historical current sources after the first port capacitor and the second port capacitor on the DC side are discretized at the previous moment; and 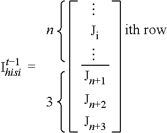
wherein
$${J}_{i} = - ( \frac{{R}_{L i}}{{R}_{L i} + {R}_{e q i}} ) {I}_{hisLi}^{t - 1} ,$$
$${J}_{n + 1} = ( \frac{{k}_{i - 1} {R}_{L i}}{{R}_{L i} + {R}_{e q i}} ) {I}_{hisLi}^{t - 1} ,$$
$${J}_{n + 2} = ( \frac{{k}_{i - 2} {R}_{L i}}{{R}_{L i} + {R}_{e q i}} ) {I}_{hisLi}^{t - 1} ,$$
$${J}_{n + 3} = 0 ,$$
and I_{hisL1}^{t-1} is a corresponding historical current source after the port inductor in the i^{th} AC side equivalent sub-circuit is discretized.

5. The method according to claim 1, wherein an expression of the multi-port Norton equivalent model is I^{t}=G^{t}U^{t}−Iₕᵢₛ^{t-1},
wherein t represents a current moment, t−1 represents a previous moment, I^{t} represents a port node current at the current moment, G^{t} represents a node admittance matrix at the current moment, U^{t} represents a port node voltage at the current moment, and Iₕᵢₛ^{t-1} represents a historical current source at the previous moment.

6. The method according to claim 1, wherein the performing electromagnetic transient simulation on the VSC by using the multi-port Norton equivalent model, to obtain a simulation result comprises:
performing electromagnetic transient simulation on the VSC according to the multi-port Norton equivalent model by using a node voltage method, to obtain the simulation result.

7. The method according to claim 6, wherein the performing electromagnetic transient simulation on the VSC according to the multi-port Norton equivalent model by using a node voltage method, to obtain the simulation result comprises:
obtaining a node admittance matrix at a current moment and a historical current source at a previous moment;
calculating a port node voltage at the current moment according to the node admittance matrix at the current moment and the historical current source at the previous moment; and
obtaining a port node current at the current moment according to the node admittance matrix at the current moment, the historical current source at the previous moment, the port node voltage at the current moment, and the multi-port Norton equivalent model, updating the node admittance matrix at the current moment and the historical current source at the previous moment, and returning to the step of calculating a port node voltage at the current moment according to the node admittance matrix at the current moment and the historical current source at the previous moment until simulation is finished.

8. An electromagnetic transient simulation apparatus for a VSC, comprising:
an equivalent circuit determining module, configured to perform circuit equivalence processing on a VSC with any number of ports based on a work mechanism of the VSC, to obtain an equivalent circuit corresponding to the VSC, wherein the work mechanism is a mechanism in which an inductor open circuit and a capacitor short circuit are not allowed inside the VSC during normal operation, the equivalent circuit comprises a DC side and an AC side, the DC side comprises three DC side port nodes, two port capacitors, and two controlled current sources, wherein a first DC side port node is connected to a second DC side port node by a first port capacitor, the second DC side port node is connected to a third DC side port node by a second port capacitor, a first controlled current source is connected to the first port capacitor in parallel, a second controlled current source is connected to the second port capacitor in parallel, and the controlled current sources are current injected into the DC side port nodes from all port branches of the AC side, and the AC side comprises one or more equivalent sub-circuits with separately represented DC sides and AC sides, and the equivalent sub-circuit comprises one AC side port node, one port inductor, one total resistor, and one switch, wherein the AC side port node is connected to one end of the switch sequentially by the port inductor and the total resistor, and the other end of the switch is configured to connect any one of the DC side port nodes, and the total resistor represents a total resistor when the equivalent sub-circuit is turned on;
an equivalent target circuit determining module, configured to perform discretization processing on the equivalent circuit, to obtain an equivalent target circuit, wherein the equivalent target circuit is a discretized equivalent circuit;
a node admittance matrix expression and historical current source expression determining module, configured to determine a node admittance matrix expression and a historical current source expression according to the equivalent target circuit;
a multi-port Norton equivalent model determining module, configured to construct a multi-port Norton equivalent model corresponding to the VSC according to the node admittance matrix expression and the historical current source expression; and
a simulation module, configured to perform electromagnetic transient simulation on the VSC by using the multi-port Norton equivalent model, to obtain a simulation result.

9. An electronic device, comprising a memory and a processor, wherein the memory is configured to store a computer program, and the processor executes the computer program, to cause the electronic device to perform the method according to claim 1.

10. Anon-transitory computer-readable storage medium, storing a computer program, wherein the computer program is executed by a processor to implement the method according to claim 1.
